(19) United States
(12) Patent Application Publication
(10) Pub. No.: US 2012/0102228 A1
(43) Pub. Date: Apr. 26, 2012

(54) INTER-DOMAIN ADVERTISEMENTS IN MULTI-DOMAIN NETWORKS

(76) Inventors: Filippo Cugini, Fidenza (IT); Piero Castoldi, Parma (IT); Annikki Welin, Solna (SE)

(21) Appl. No.: 13/256,764

(22) PCT Filed: Apr. 28, 2009
(86) PCT No.: PCT/EP2009/055111

§ 371 Date: Dec. 30, 2011

(30) Foreign Application Priority Data
Mar. 16, 2009 (EP) 091552182

(51) Int. Cl. G06F 15/173

(52) U.S. Cl. 709/242

(57) ABSTRACT

In a multi-domain network each domain, or Autonomous System (AS), has a route calculation entity (PCE A) which is responsible for computing paths between domains on behalf of clients. The route calculation entity (PCE A) sends advertisement messages to a route calculation entity (PCE B) in another domain. The advertisement message carries at least one of: inter-domain resource information and aggregated intra-domain information, such as simplified topology information or cumulative traffic engineering (TE) metrics. The inter-domain resource information can be inter-domain route or reachability information which is normally discarded by a routing protocol such as the Border Gateway Protocol (BGP) and can include inter-domain Traffic Engineering (TE) information such as reservable bandwidth.

### TECHNICAL FIELD

This invention relates to advertising information in a multi-domain network.

### BACKGROUND

In a multi-domain network each domain, also called an Autonomous System (AS), is under the control of a different Administrative Authority. This complicates the problem of routing traffic across the network. The Border Gateway Protocol (BGP), described in the Internet Engineering Task Force (IETF) Request For Comments (RFC) RFC4271, is the most widely used routing protocol for multi-domain networks. BGP advertises reachability information between domains. BGP is used to scale to full Internet-wide use and, accordingly, a domain is typically only permitted to advertise a single route between a pair of domains. This restricts, or prevents, the possibility of performing traffic engineering (TE) techniques such as load-balancing and providing protection paths.

The IETF has proposed a Path Computation Element (PCE)-based architecture in RFC4655 to provide constraint-based path computations both in single and multi-domain networks. In a PCE-based architecture, a domain has a Path Computation Element (PCE) which is capable of computing a network path, or route, based on a network graph and applying computational constraints. The PCE calculates a route on behalf of Path Computation Clients (PCC) in the domain. A PCC submits a request for a route calculation to the PCE and receives a route in reply. The PCE-based architecture reduces computation load on nodes in the network, and effectively separates the tasks of packet forwarding (which remains at the node) and route calculation (now performed at the PCE).

In multi-domain networks, the PCE-based path computation across domains is complicated by the limited visibility of Traffic Engineering (TE) information which is usually restricted to a single domain. Two procedures called Per-Domain and Backward Recursive PCE-based Computation (BRPC) have been proposed to overcome this limitation. The BRPC procedure has been designed to compute optimal multi-domain paths. It uses the PCE communication Protocol (PCEP) to allow the PCE controlling the destination domain to initiate in a reverse fashion the recursive path computation along the sequence of domains to be traversed, towards the PCE controlling the source domain. The PCEP protocol allows the Path Computation Client (PCC), e.g. the Network Management System (NMS) or the source PCE, to specify the sequence of domains to be traversed. Such sequence is included within the PCEP Include Route Object (IRO) carried in the PCEP PCReq message.

However, the present inventors have appreciated that the limited amount of resource information typically exchanged among domains through the Border Gateway Protocol (BGP), and the acquisition of multi-domain resource information from BGP databases, has the consequence that a PCE will typically only consider one sequence of domains per network prefix. The Per-Domain and BRPC procedures may then be applied along a non-optimal sequence of domains, thus potentially affecting the overall network performance. In addition, such limitation may completely prevent the path computation subject to domain diversity (e.g. for protection purposes). It is possible to run BRPC over additional routes not advertised by BGP by, for example, setting policies at domains which force a PCE to consider a pre-defined route. However, depending on network conditions, the pre-defined route may offer poor performance.

### SUMMARY

An aspect of the invention provides a method for use in a multi-domain network, wherein each domain has a route calculation entity which is responsible for computing paths between domains on behalf of clients, the method comprising at a route calculation entity in a first of the domains:
sending an advertisement message to a route calculation entity in another of the domains, the message carrying at least one of:
   inter-domain resource information for an inter-domain route;
   aggregated intra-domain resource information.

The advertisement messages sent between route calculation entities allow route calculation entities in different domains, or Autonomous Systems, to advertise resource information typically not advertised by existing inter-domain routing protocols such as the Border Gateway Protocol (BGP). The advertisement messages enable effective path computations by the route calculation entity and helps to preserve network stability, scalability and intra-domain confidentiality. The inter-domain resource information comprises at least one of: inter-domain route information indicating a possible route between domains (which can also be called reachability information); and inter-domain Traffic Engineering (TE) information. The Traffic Engineering information is typically used for traffic engineering purposes and can comprise a metric which represents any of: path length, bandwidth, delay, packet loss, jitter. Conventionally, TE information is not advertised outside of a domain by existing protocols. Accordingly, the present method provides a way of advertising this resource/TE information between domains.

An advantage of the method is that it does not add a significant additional message or processing load on the network because the advertisement messages are exchanged by the route calculation entities, and information carried within the advertisement messages is only inspected, and stored, at the route calculation entities. This contrasts with routing protocols in which the content of advertisement messages may be inspected, and stored, at all routers along the path of the advertisement message.

Advantageously, the route calculation entity is a Path Computation Element (PCE), as defined by RFC4655, or a similar entity. The advertisement message can be a Path Computation Element communication Protocol (PCEP) message.

Another aspect of the invention provides a method for use in a multi-domain network, wherein each domain has a route calculation entity which is responsible for computing paths between domains on behalf of clients, the method comprising at a route calculation entity in one of the domains:
receiving an advertisement message from a route calculation entity in another domain, the message carrying at least one of:
   inter-domain resource information for an inter-domain route;
   aggregated intra-domain resource information.

Further aspects of the invention provide a route calculation entity which is responsible for computing paths between domains of a multi-domain network on behalf of clients, the route calculation entity configured to perform any of the method steps.

The functionality described here can be implemented as hardware, software, or a combination of these. Accordingly, a further aspect of the present invention provides machine-readable instructions (software) for causing a processor to perform the method. The machine-readable instructions may be stored on an electronic memory device, hard disk, optical disk or other machine-readable storage medium. The machine-readable instructions can be downloaded to a processor via a network connection.

### BRIEF DESCRIPTION OF THE DRAWINGS

Embodiments of the invention will be described, by way of example only, with reference to the accompanying drawings in which: FIG. 1 shows a network with multiple Autonomous Systems (AS) and a Path

Computation Element (PCE) in each AS;

FIG. 2 shows a possible topology of an Autonomous System;

FIG. 3 shows another possible topology of an Autonomous System;

FIG. 4 schematically shows a Path Computation Element (PCE) and a Border Router or Route Reflector within an AS;

FIG. 5 shows message flows between Autonomous Systems to advertise reachability information;

FIG. 6 shows message flows between Autonomous Systems to advertise bandwidth information;

FIG. 7 shows an example message format for advertising bandwidth information;

FIG. 8 shows a method performed by a PCE when sending an advertisement message;

FIG. 9 shows a method performed by a PCE when receiving an advertisement message;

FIG. 10 shows simulation results comparing the performance of a BGP scheme with embodiments of the invention.

### DETAILED DESCRIPTION

FIG. 1 shows a multi-domain network topology 10 with five domains, also called Autonomous Systems (AS), shown as AS A-AS E. In this description the terms “Autonomous System” and “domain” are used interchangeably. Each Autonomous System has one or more border routers BR which connect, via communication links 12, to border routers BR in other domains. As an example, Autonomous System AS B has a border router BR B_{C} connecting to AS C, a border router BR B_{D} connecting to AS D and a border router BR B_{A} connecting to AS A. The Border Gateway Protocol (BGP) is performed between border routers to advertise reachability information. Adjacent Autonomous Systems are peers for the Border Gateway Protocol (BGP). BGP decisions give preference to routes that traverse the smallest number of Autonomous Systems (i.e. with the shortest BGP AS_PATH). In the case of two routes having an equal number of traversed Autonomous Systems, as in default BGP configurations, tie-breaking rules are performed (e.g. first learned, smaller IP prefix, etc.) and just one route is stored in the forwarding table and propagated to peer domains.

A Path Computation Element (PCE), according to RFC4655, is located in each

Autonomous System AS. The PCE is responsible for path computation, and receives requests for path computations from clients, called Path Computation Clients (PCC) located within the AS. A router within AS B is shown as an example of a PCC. Typically, there is one PCE per AS and one advantageous configuration is to co-locate the PCE with a BGP Route Reflector (RR) for that AS. The PCE collects multi-domain resource information from the RR BGP database(s). PCEs in different Autonomous Systems communicate with each other to establish a route between Autonomous Systems. FIG. 1 schematically shows communication paths between PCEs (e.g. a link 11 between PCE A and PCE B). It will be appreciated that inter-PCE messages pass via the intra-domain communication links (not shown), border routers BR and inter-AS links 12.

In order to understand embodiments of the invention, conventional operation of the network 10 will be described. In the example network of FIG. 1 Autonomous System AS E originates the prefix p_{E}. AS B will receive BGP Update messages announcing prefix p_{E} reachable through both route B-C-E and route B-D-E. However, even if the two routes have the same BGP AS_PATH length, just one of them, e.g. B-C-E, is selected and then propagated to AS A. Two examples of possible route computations will now be considered. For the first example, consider that a connection c_{BE} is required from a source node in AS B with the prefix p_{B} to a destination node in AS E with the prefix p_{E}. PCE B is aware of two different routes passing through AS C and AS D respectively. This knowledge can be exploited for example to run BRPC procedure over both routes, i.e. to compute the optimal path or to perform AS-disjoint path computations. For the second example, consider that a connection c_{AE} is required from a source node in AS A (source prefix p) toward a destination node in AS E (prefix p_{E}). PCE A is only aware of the route passing through AS C, because this is the only BGP reachability information that was propagated by AS B. AS A does not know of the route passing through AS D. This limited knowledge does not allow PCE A to run BRPC procedure over the two equal shortest routes (A-B-C-E and A-B-D-E) to compute the optimal multi-domain path. Consider also that a connection c_{BD} is required from a source node in AS B with the prefix p_{B} to a destination node in AS D with the prefix p_{D}. PCE B is aware of just the direct route to AS D since the route traversing AS C and AS E is removed by AS E due to its longer BGP AS_PATH. However, this prevents the computation of AS-disjoint routes or even optimal routes if the links between AS B and AS D are overloaded.

In embodiments of the present invention, PCEs advertise additional information between Autonomous Systems.

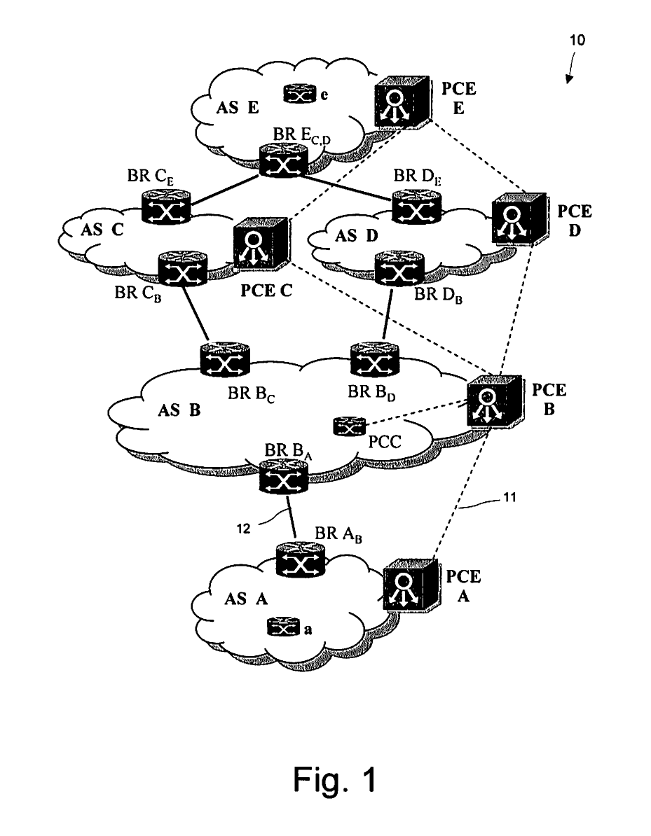

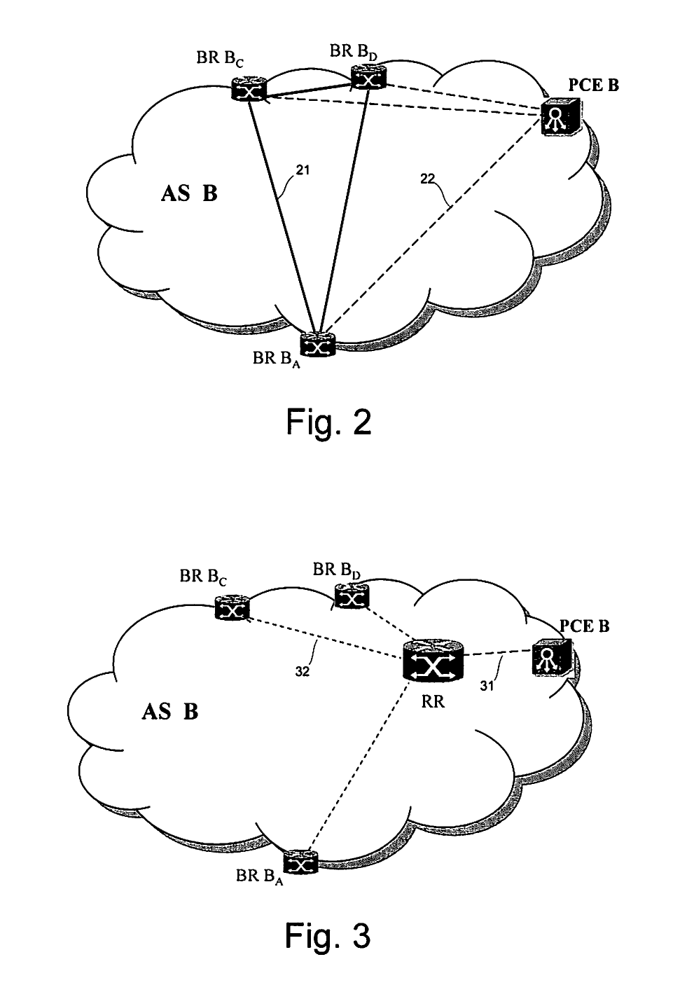

FIGS. 2 and 3 show two possible topologies of an Autonomous System. In FIG. 2, Autonomous System AS B has a set of border routers BR B_{C}, BR B_{D}, BR B_{A} which are connected, internally within the AS, by a mesh topology of communication links 21. Each border router performs External BGP with other Autonomous Systems, and Internal BGP (IBGP) with the other border routers of that AS. A Path Computation Element PCE B for the AS connects 22 to the border routers, to collect BGP information about other Autonomous Systems. Although the set of BRs share reachability information, a BR in the set may only propagate one selected inter-AS route to other BRs in the set, rather than propagating all possible routes. Accordingly, it is advantageous that the PCE connects to each of the set of border routers so that the PCE is aware of all possible inter-AS routes.

In FIG. 3, a single Router Reflector performs External BGP for the AS. PCE B connects 31 to the Route Reflector to gather BGP information. Each of the border routers BR B_{C}, BR B_{D}, BR B_{A} (which may also be called edge routers) connects 32 to the Route Reflector RR, and therefore the RR is aware of all possible inter-AS routes.

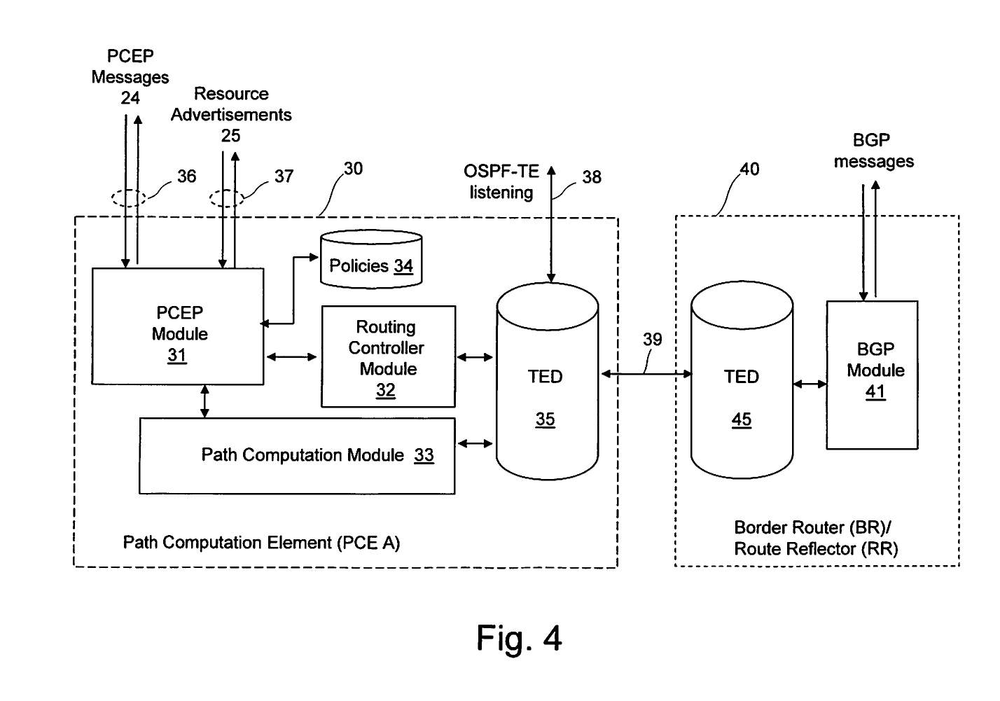

FIG. 4 shows a Path Computation Element (PCE) 30 of an AS and a Border Router (BR) or Route Reflector (RR) 40 of the same AS. The Border Router/Route Reflector 40 is a conventional element of an AS. A BGP module 41 performs the External BGP protocol with Border Routers in other Autonomous Systems and stores a database TED 45 of reachability data. As described above, part of the BGP protocol involves advertising limited reachability information to other Autonomous Systems.

PCE 30 comprises a PCE-protocol (PCEP) module 31, a Routing Controller Module 32, a Path Computation module 33 and a database 35. Traffic Engineering

Database (TED) 35 stores traffic engineering information which can be used to compute routes within the AS, and routes between Autonomous Systems. Database 35 can be populated by acquiring information, via an interface 39, from database 45. Database 35 can store information such as topology, bandwidth information (e.g. total bandwidth, available bandwidth), QoS constraints. The database 35 contains both intra and inter-domain routing information. The database 35 is shown schematically in FIG. 4 as a single database located at the PCE, although it can comprise a set of databases which are commonly located, or distributed. Also, it is possible for the PCE and BR/RR to share a common database, or set of databases. Database 35 can store current IP/MPLS routing tables built from the information stored in different databases, each of which related to a specific routing protocol. Information about available/reservable bandwidth within the AS can be acquired by listening, via an interface 38, to Open Shortest Path First-Traffic Engineering (OSPF-TE) messaging within the AS. Various mechanisms can be used to ensure that the data held in database 35 is current. These include downloading information from database(s) 45, such as in XML form. It will be appreciated that OSPF-TE (as refined by RFC5392) flooding is described as one possible way of how the PCE can learn about inter-domain resource/TE information. The PCE can listen to other signalling protocols to obtain the resource/TE information. If another network entity within the domain has knowledge of this information, the PCE can obtain the resource/TE information by downloading it from that network entity, in a similar manner as for route/reachability information.

PCEP module 31 performs the PCE-Protocol. PCEP messages 24 include path computation requests (PCReq) and replies (PCRep) sent via interface 36. These messages 24 are exchanged with PCCs or PCEs in the AS or in other ASs. Requests can be originated either by elements belonging to AS A (e.g. a network node) or by elements belonging to other Autonomous Systems (e.g. a remote PCE). Resource advertisement messages 25 are exchanged with PCEs in other Autonomous Systems via interface 37. Advantageously, PCEP module 31 uses policy information 34 to determine which other Autonomous Systems the PCE is authorised to communicate with.

The Path Computation Module 33 is responsible for path/route computations, i.e. it runs algorithms and heuristics that perform route computation in response to requests 24 received by the PCEP module 31, the path computations using the information stored in the TED 35. The computed path/route is then returned to the PCEP module 31 for returning to the requesting entity.

The Routing Controller Module (RCM) 32 elaborates and stores within the TED 35 the inter-domain routing information received from the PCEP module through advertisement messages 25. In addition, RCM 32 extracts the intra-domain information to be advertised to other domains from the TED 35 and sends it to the PCEP module 31, where it is packaged into a suitable form for transmission. It will be understood that the functions performed by the modules 31, 32, 33 can be implemented by a single processor, or a plurality of processors.

In accordance with embodiments of the invention, the PCE advertises resource information in the form of at least one of: inter-domain resource information comprising, for example, available/reservable bandwidth information for an inter-domain route; inter-domain route/reachability information comprising information about a possible route between domains; aggregated intra-domain resource information.

Additional PCEP messages 25, which will be called PCEP Resource Advertisement (PCRA) messages, carry the additional resource information typically not exchanged between Autonomous Systems through BGP advertisements. Two main categories of resource information can be enclosed within PCRA messages:
1) Inter-domain resource information. Two different advertisement solutions are considered.
2) Intra-domain resource information.
   The resource information carried in these advertisement messages is sent to other PCEs and stored in the TED database 35 at each PCE. The resource information is used by the Path Computation Module 33 at PCEs to improve the quality of the computation of the routes computed between domains.

### Advertising Inter-Domain Resource Information

Two types of inter-domain resource information will be considered: (i) inter-domain route/reachability information typically not advertised by BGP for scalability reasons, and (ii) traffic engineering information, such as bandwidth information for links to other Autonomous Systems.

As described above, BGP usually propagates a single route between Autonomous Systems so as not to overload border routers with a large amount of reachability information. The PCE advertises reachability information about other routes which are normally discarded by the External BGP protocol. This alternative route information can be advertised in new messages which will be called Route-PCRA (R-PCRA) messages. In particular, the available and stable route information provided by adjacent BGP peers, referred to prefixes belonging to a limited set of authorised domains, and discarded by tiebreaking rules, are exchanged through R-PCRA messages. This does not violate confidentiality requirements since such routes are removed by BGP only for scalability reasons. Two sets of route information can be announced. The first set of route information considers all inter-domain routes with the same BGP AS_PATH length. Considering again the example network of FIG. 1, the BGP signalling from AS B only advertised the route B-C-E to AS A. However, the R-PCRA advertisement message now advertises the route B-D-E to PCE A in AS A. Connection c_{AE} is now computed taking into account both the routes A-B-C-E and A-B-D-E. Thus, PCE A can even compute the optimal path on both sequences of domains and select the best one. The second set of route information includes routes traversing a higher number of domains (i.e. with longer BGP AS_PATH). In this case, which requires an higher amount of exchanged information through PCEs, also connection c_{BD} could take advantage of the knowledge of the alternative route (i.e., the longer B-C-E-D route), in case of domain-disjoint path computation. To prevent loops from occurring, the same node/AS should not occur more than once within the advertised route.

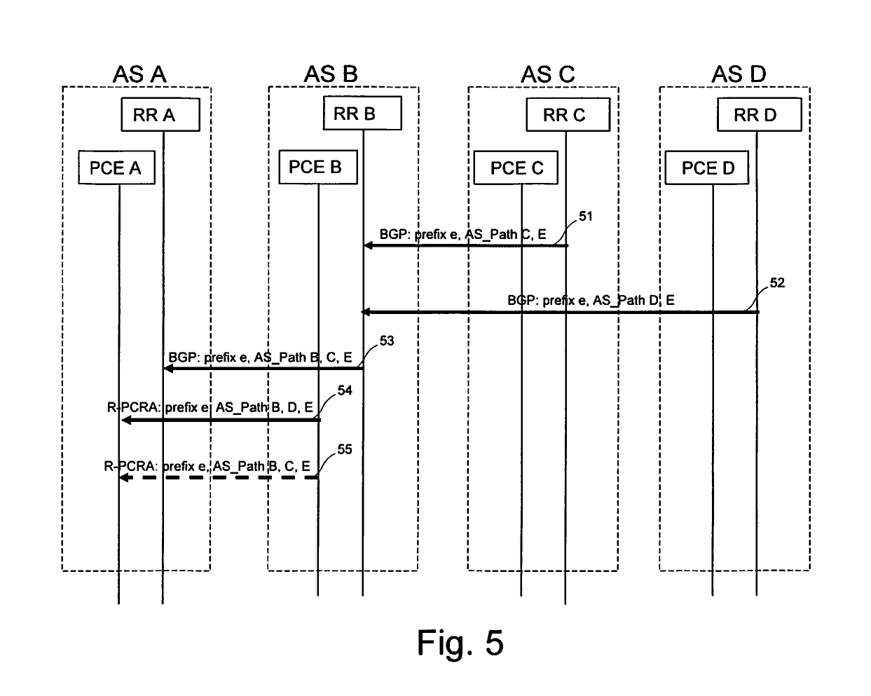

FIG. 5 shows the BGP messages 51, 52, 53 exchanged between Autonomous Systems of FIG. 1. AS B receives advertisements indicating that AS E is reachable via the routes B-C-E 51 and B-D-E 52. The Route Reflector (or Border Routers) of AS B then selects route B-C-E as the single route to reach AS E, and advertises this route by BGP message 53. The route B-D-E that was discarded by the BGP selection process is advertised by a R-PCRA message 54. The R-PCRA messages can advertise only routes that it is known are not advertised by BGP. Alternatively, the R-PCRA messages can advertise a full set of routes, including those which are advertised by BGP, as shown by message 55 in FIG. 5. Advantageously, an inter-domain R-PCRA advertisement message carries: an identifier of a prefix, a list of Autonomous Systems that can be traversed to reach that prefix. The list of Autonomous Systems can be in the form of a path vector, as used in BGP. The R-PCRA message can include other information, such as a TE metric or a bandwidth value of the type described below.

A second type of inter-domain information that can be advertised by the PCEs is the presence of inter-domain links together with a traffic engineering (TE) parameter, such as their available/reservable bandwidth. This information can be carried in messages which will be called Bandwidth-PCRA (B-PCRA) messages. Bandwidth information is not advertised by the routing protocol BGP. A possible way for the PCE to collect bandwidth information is to listen to OSPF-TE flooding, when the OSPF-TE signalling includes the extensions described in RFC5392. Such extensions allow the advertisement within an AS A of the TE info (including bandwidth) of an inter-domain link between AS A and another domain, say AS B. Within AS A only the bandwidth information of the link from A to B will be advertised. Thus PCE A, by simply listening to the OSPF flooding, will be aware of the bandwidth information of the link from A to B, which will be called X_{AB}. Similarly, PCE B will be aware of just the bandwidth information of the link from B to A, which will be called X_{BA}. Accordingly, through a combination of the OSPF-TE messaging described in RFC5392 and the new B-PCRA messages, AS A and AS B can exchange the bandwidth information that they have obtained from their own AS and thereby become aware of the bandwidth in both inter-AS directions X_{AB}. and X_{BA}. Conventionally, routing protocols such as OSPF-TE advertise bandwidth information only within an AS. The advertised bandwidth information can refer to the amount of reservable bandwidth on inter-domain links that adjacent peer Autonomous Systems agree to make available for remote (and authorised) Autonomous Systems. The advertisement of this kind of information should not affect confidentiality requirements, since it does not disclose intra-domain information or private inter-domain agreements. One option for the B-PCRA messages is to use the same path vector routing structure as for BGP and R-PCRA. For example, considering an R-PCRA message with: Prefix: e; AS_PATH: B, D, E and BW: X_{B,D,E}. The term “BW: X_{B,C,E}” represents the total reservable bandwidth for the end-to-end route between ASB and AS E.

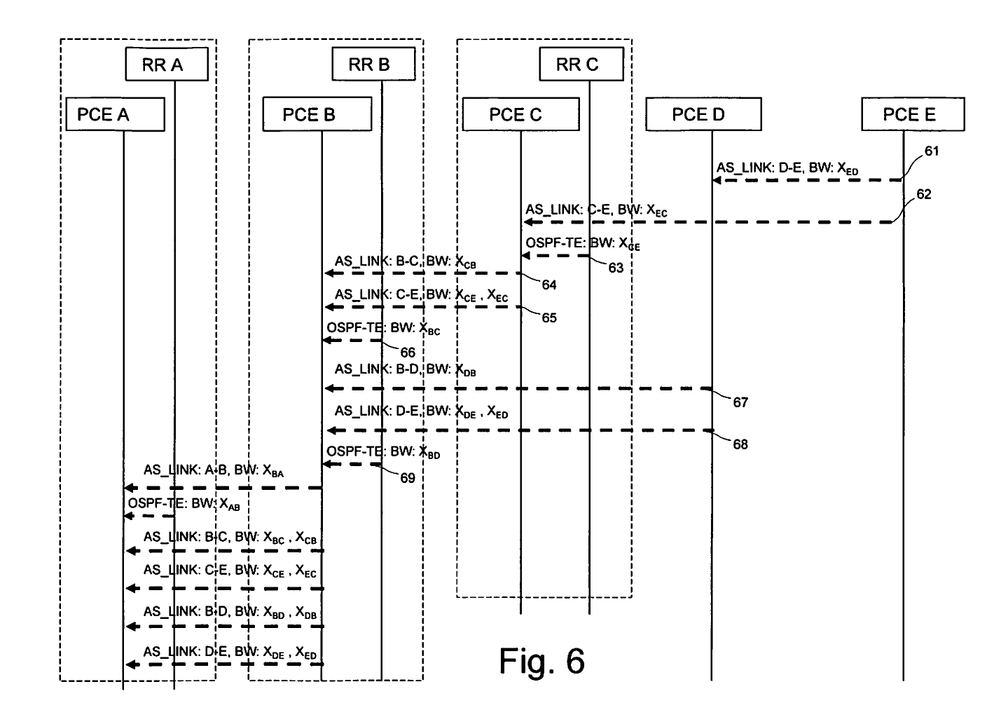

Another option for the B-PCRA messages is to use a link-state routing structure. Each PCE receives, from the PCEs in the adjacent Autonomous Systems, advertisements of remote inter-domain links. FIG. 6 shows message flows for advertising inter-AS bandwidth availability in the network of FIG. 1. PCE E sends a message 61 to PCE D which identifies the link (D-E) and the bandwidth available/reservable at AS E (X_{ED}). Similarly, PCE E sends a message 62 to PCE C which identifies the link (C-E) and the bandwidth available/reservable at AS E (X_{EC}). At AS C, PCE C sends a message 64 to PCE B which identifies the link (B-C) and the bandwidth available/reservable at AS C (X_{CB}). PCE C listens to OSPF-TE messages 63 within AS C and learns of the bandwidth available at AS C (X_{CE}) for the link between AS C and AS E. PCE C sends a message 65 which advertises bandwidth for the inter-AS link (C-E). Message 65 includes the bandwidth available/reservable at AS E (X_{EC}), which was received in the inter-PCE message 62, and the bandwidth available/reservable at AS C (X_{CE}), which was learned from listening to OSPF-TE message 63. PCE B receives messages 64, 67 advertising bandwidth for the inter-AS links which directly connect AS B to AS C and AS D. PCE B also receives messages 65, 68 advertising bandwidth of inter-AS links which are not directly connected to AS B; message 65 carries bandwidth information about the inter-AS link (C-E) and message 68 carries bandwidth information about the inter-AS link (D-E). Moving on to PCE A, PCE A receives B-PCRA messages from PCE B advertising the reservable bandwidth of the inter-AS link A-B, as well as the four inter-AS links B-C, B-D, C-E, and D-E.

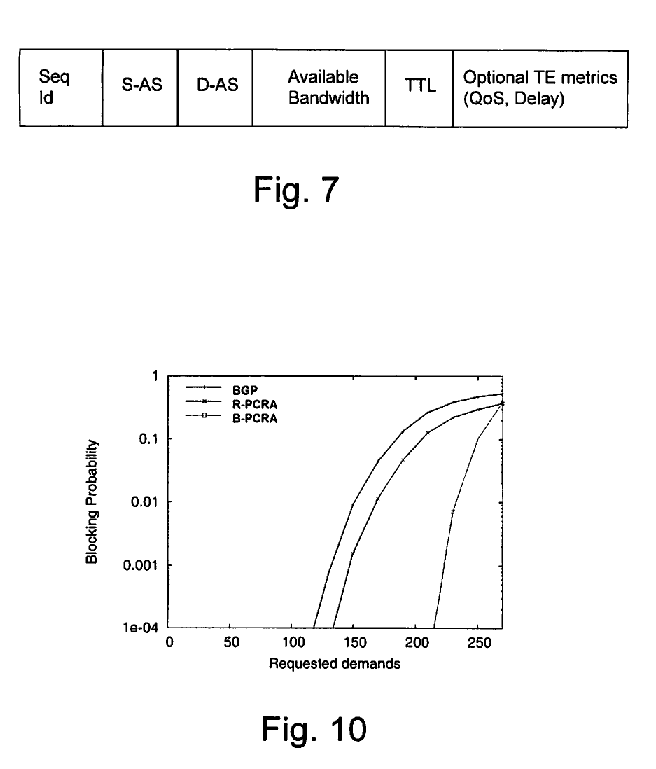

Advantageously, the B-PCRA message carries the following minimum set of information: source AS, destination AS and reservable bandwidth. For scalability reasons, multiple inter-domain links between the same pair of adjacent domains can be advertised as a single link with an available bandwidth equal to the sum of all available link bandwidths. Policies and Time-To-Live (TTL) mechanisms can also be implemented in order to limit the inter-domain link advertisement to a restricted set of domains (e.g., B-PCRA information with TTL=5 will be forwarded to reach all authorised domains in the range of five domains). Mechanisms can be implemented to minimise the number of exchanged B-PCRA messages, such as sending a new message when bandwidth passes (or changes by) certain threshold values and granularities. FIG. 7 shows a possible format of a B-PCRA message, where:
Seq ID=Sequence ID;
S-AS=source AS;
D-AS=destination AS;
Available bandwidth=summary of available bandwidth between the identified pair of adjacent domains;
TTL=Time-To-Live (TTL) mechanism.
   Other TE metrics can also be carried within the message, such as path length, packet loss, Quality of Service (QoS), delay, jitter etc.

Inter-domain bandwidth and, more particularly, reservable bandwidth on inter-domain links that adjacent peer Autonomous Systems agree to make available for remote (and authorised) Autonomous Systems, is considered to be the most useful TE metric that can be advertised. However, it is possible to advertise any other TE metric in addition to, or instead of, bandwidth in the same manner as described above for advertising bandwidth values.

### Advertising Intra-Domain Resource Information

Intra-domain information can be advertised to other domains. Due to confidentiality and scalability reasons, the advertisement of detailed intra-domain resource information is not realistic. However, several topology aggregation methods (e.g., Simple Node, Full Mesh, Star) have been proposed to be effectively applied in multi-domain networks. Example ways of aggregating topology information are described in G. Maier et al, “Multi-Domain Routing Techniques with Topology Aggregation in ASON Networks”, ONDM '08, March 2008.

Another category of advertisement messages advertise the aggregated intra-domain topology information to other domains. The aggregated intra-domain resource information can indicate connections between border nodes of the domain. The aggregated topologies are then utilized to compute both the sequence of domains to be traverse and the border nodes of each traversed domain. This solution could be particularly beneficial to compute optimal multi-domain paths without sending BRPC requests along each possible sequence of domains. It is also useful in cases where the BRPC procedure is not supported. As an example, consider that: in AS C the intra-domain path between the two BRs is 1000 km and comprises 10 nodes; and in AS D the intra-domain path between the two BRs is 20 km and comprises 2 nodes. Thus, if such information is available it is possible to obtain a more precise TE solution, such as selecting the path with lowest end-to-end delay.

The advertised intra-domain information can include a traffic engineering metric such as bandwidth, delay, packet loss or jitter. Multiple metrics can be advertised. Advantageously, the advertised metric is a cumulative value of the measured quantity (bandwidth, delay etc.) within the domain.

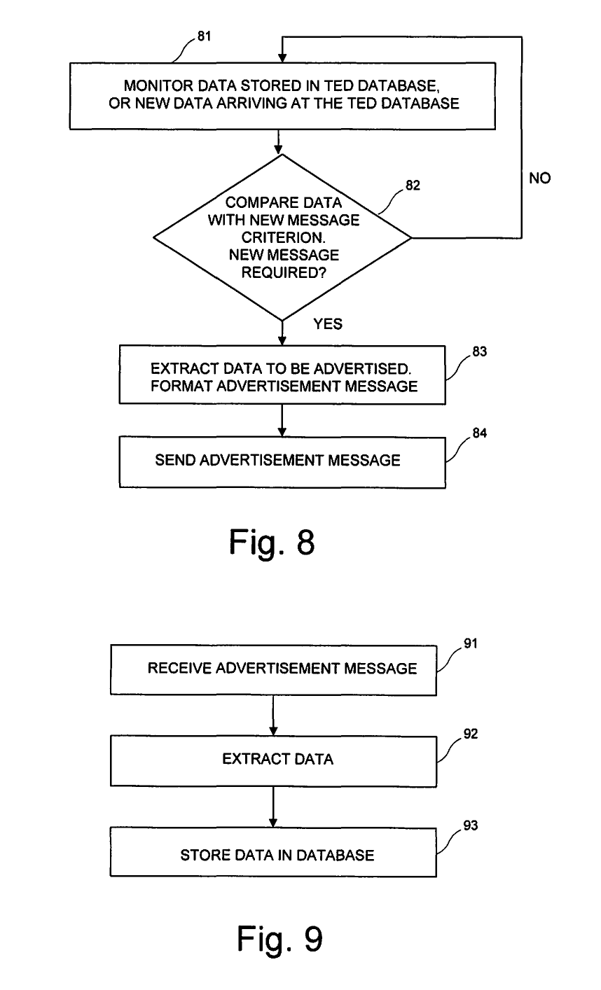

FIG. 8 shows a method performed at a PCE when sending an advertisement message. Firstly, at step 81, the PCE monitors data stored in the database 35, or new data arriving at database 35 (e.g. from the RR). At step 82 the data is compared with at least one criterion for sending a new message. Examples of possible criteria are: a new route which has not previously been advertised; a new route which has not previously been advertised by BGP; a route which has not been advertised for the last T minutes; bandwidth on a link crossing a threshold value; bandwidth on a link changing by a threshold amount; a change to the environment. If one of the criteria are met, then data is extracted at step 83 and a new message is formatted. At step 84 the new advertisement message is sent to another PCE. Advantageously, the rate of issuing advertisements is kept as low as possible to avoid convergence and scalability problems.

FIG. 9 shows a method performed at a PCE when receiving an advertisement message. At step 91 an advertisement message is received. At step 92 data is extracted from the message by the routing controller module 32. At step 93 the extracted data is stored in the database. As part of step 93, the PCE can check if it already has the information that it received in the advertisement message. If so, the information is ignored.

For scalability, it is advantageous that the advertisement messages that have been described are used within a restricted set of domains, and are not used throughout the entire Internet. For example, the advertisements can be exchanged between a set of domains with known relationships, like the peering relationships (e.g. a set of 20 domains described in the PCE RFC4657). In terms of message reliability, all PCEP messages exploit TCP protocol, i.e. they do not require additional specific acknowledgment or refresh mechanisms. Finally, in terms of network stability, both R-PCRA and B-PCRA updates only influence new path computations (in particular those referring to high quality traffic that require constraint-based multi-domain path computation) and do not affect the network operations, the forwarding of Best Effort traffic or already established high quality Label Switched Paths (LSP). This is particular important if compared to alternative solutions to provide multi-domain TE capabilities, for example those based on TE extensions to the BGP protocol that potentially affect the overall network stability and scalability.

Finally, the proposed communication between PCEs could be beneficial also in case of network failures. In particular, a PCE notified of network failures affecting resources belonging to the controlled domain, could immediately notify remote and trusted PCEs about the failure. In this way, remote PCEs could become aware of network failures before receiving the related BGP message Update (typically slow). This allows remote PCEs to speed up the re-computation of failed multi-domain paths and avoids that new multi-domain path computations consider the failed resources.

FIG. 10 shows simulation results for the performance of a multi-domain network comprising a 4×4 mesh topology. Each of the N=16 nodes represents an AS controlled by a PCE. Each of the L=24 links represents a bidirectional link between adjacent domains. Each link is composed of one (or multiple) physical link, with an overall capacity equal to C=40 Gbps. Connection requests are sequentially generated with uniform distribution among all domain pairs. Each connection requires a capacity c=1 Gbps. Path computation considers only routes with shortest AS_PATH length. For simplicity, intra-domain resources do not cause path computation failures, which are determined by the lack of inter-domain resources. FIG. 8 shows the blocking probability obtained in case of path computations performed resorting to resource information retrieved by (i) BGP only, (ii) BGP and R-PCRA, (iii) B-PCRA. In particular, BGP-based results are obtained considering the RR database only (as in the example in FIG. 1) and performing random load balancing in case of equal length routes. R-PCRA results are obtained by resorting to both the information included in the RR database and collected through R-PCRA. In case of multiple equal cost paths, random load balancing is still performed. However, compared to the BGP-based path computation, the amount of known and exploitable equal length routes is typically higher and the blocking probability results show the related performance improvement. Path computation based on B-PCRA messages achieves the best performance. Indeed, besides the knowledge of all possible equal cost routes as in R-PCRA, the availability of link bandwidth information allows to select proper TE schemes such as least used routing policies.

The functional modules and method steps described above may be implemented as electronic hardware, as software modules executed by a processor, or as combinations of both. They may be implemented by, or performed by, a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the described functions.

The invention is not limited to the embodiments described herein, which may be modified or varied without departing from the scope of the invention.

1-26. (canceled)

27. A method for use in a multi-domain network, wherein each domain has a route calculation entity which is responsible for computing paths between domains on behalf of clients, the method comprising at a route calculation entity in a first of the domains:
sending an advertisement message to a route calculation entity in another of the domains, the message carrying at least one of:
inter-domain resource information for an inter-domain route;
aggregated intra-domain resource information.

28. A method according to claim 27 wherein the inter-domain resource information carried within the advertisement message comprises at least one of:
inter-domain route information indicating a possible route between domains;
inter-domain traffic engineering information.

29. A method according to claim 28 wherein the network uses a routing protocol to advertise route information and wherein the inter-domain route information carried within the advertisement message comprises information which is not advertised by the routing protocol.

30. A method according to claim 28 where the network uses a routing protocol in which a router in a domain selects, and advertises, a route between domains and wherein the inter-domain route information carried within the advertisement message is at least one alternative route between domains which is not advertised by the routing protocol.

31. A method according to claim 30 where the alternative route between domains is at least one of:
a route which traverses the same number of domains than the route selected by the routing protocol; and,
a route which traverses a higher number of domains than the route selected by the routing protocol.

32. A method according to claim 28 wherein the advertisement message carries inter-domain route information and at least one traffic engineering metric for the route which represents at least one of: path length, bandwidth, delay, packet loss, jitter.

33. A method according to claim 28 wherein the inter-domain traffic engineering information comprises information about at least one of: bandwidth, path length, delay, packet loss, jitter.

34. A method according to claim 33 wherein the advertisement message carries aggregated bandwidth information for a plurality of links which share the same inter-domain route.

35. A method according to claim 27 further comprising:
listening to advertisements of inter-domain traffic engineering information advertised within the first domain; and
including the inter-domain bandwidth information in the advertisement message.

36. A method according to claim 27 wherein the aggregated intra-domain resource information is a simplified topology of the domain.

37. A method according to claim 27 wherein the aggregated intra-domain resource information includes a cumulative traffic engineering metric for the domain.

38. A method according to claim 27 wherein the advertisement message carries information to limit propagation of the message.

39. A method according to claim 27 further comprising:
monitoring a database of traffic engineering data;
determining when at least one new message criterion is met; and,
sending the advertisement message when the criterion is met.

40. A method for use in a multi-domain network, wherein each domain has a route calculation entity which is responsible for computing paths between domains on behalf of clients, the method comprising at a route calculation entity in a first of the domains:
receiving an advertisement message from a route calculation entity in a second of the domains, the message carrying at least one of:
inter-domain resource information for an inter-domain route;
aggregated intra-domain resource information.

41. A route calculation entity for use in a first domain of a multi-domain network, the route calculation entity comprising:
an input arranged to receive resource information from the first domain;
a memory arranged to store the resource information;
a processor arranged to construct an inter-domain advertisement message for sending to a route calculation entity in another of the domains, the advertisement message carrying at least one of: inter-domain resource information for an inter-domain route and aggregated intra-domain resource information;
an interface arranged to output the inter-domain advertisement message.

42. A route calculation entity according to claim 41 wherein the processor is further arranged to calculate a route between domains using resource information stored in the memory.

43. A route calculation entity according to claim 41 wherein the inter-domain resource information carried within the advertisement message comprises at least one of:
inter-domain route information indicating a possible route between domains;
inter-domain traffic engineering information.

44. A route calculation entity according to claim 41 wherein the network uses a routing protocol to advertise route information and wherein the processor is arranged to construct an inter-domain advertisement message to carry inter-domain route information which is not advertised by the routing protocol.

45. A route calculation entity according to claim 41 wherein the interface is further arranged to receive an advertisement message from a route calculation entity in another of the domains and the processor is further arranged to store resource information carried in the advertisement message in the memory.

46. A route calculation entity for use in a first domain of a multi-domain network, the route calculation entity comprising:
an input arranged to receive an advertisement message from a route calculation entity in another of the domains, the advertisement message carrying at least one of:
inter-domain resource information for an inter-domain route and aggregated intra-domain resource information;
a memory;
a processor arranged to store the resource information carried in the advertisement message in the memory.

47. A route calculation entity according to claim 46 wherein the processor is further arranged to calculate a route between domains using resource information stored in the memory.

48. A machine-readable carrier carrying machine-readable instructions for causing a processor to perform a method for use in a multi-domain network, wherein each domain has a route calculation entity which is responsible for computing paths between domains on behalf of clients, the method comprising at a route calculation entity in a first of the domains:
sending an advertisement message to a route calculation entity in another of the domains, the message carrying at least one of:
inter-domain resource information for an inter-domain route;
aggregated intra-domain resource information.
